(19) United States
(12) Patent Application Publication
(10) Pub. No.: US 2026/0179315 A1
(43) Pub. Date: Jun. 25, 2026

(54) APPARATUS AND METHOD FOR PROCESSING SENSOR DATA, SENSOR SYSTEM

(71) Applicant: Robert Bosch GmbH, Stuttgart (DE)

(72) Inventors: Bastian Bischoff, Gerlingen (DE); Daniel Koehler, Leonberg (DE); Daniel Niederloehner, Stuttgart (DE); Daniel Kenta Jenet, Stuttgart (DE); Karim Adel Dawood Armanious, Stuttgart (DE); Maurice Quach, Ditzingen (DE); Michael Ulrich, Stuttgart (DE); Patrick Ziegler, Waiblingen (DE); Ruediger Jordan, Stuttgart (DE); Sascha Braun, Eningen Unter Achalm (DE)

(21) Appl. No.: 19/129,082

(22) PCT Filed: Jan. 16, 2024
(86) PCT No.: PCT/EP2024/050850

§ 371 Date: May 12, 2025

(30) Foreign Application Priority Data
Feb. 15, 2023 (DE) 10 2023 201 275.8

(51) Int. Cl. G06T 17/00; G06F 18/214; G06N 3/045; G06N 3/0464; G06N 3/063; G06N 3/08; G06N 3/084; G06V 10/80; G06V 10/82

(52) U.S. Cl. CPC G06T 17/00; G06F 18/214; G06N 3/045; G06N 3/0464; G06N 3/063; G06N 3/08; G06N 3/084; G06V 10/80; G06V 10/82

(57) ABSTRACT

Processing of sensor data from sensor(s). The sensor data are provided as an unordered point cloud. The points of the unordered sequence are then converted into a regular structure using a point-processing neural network and made available for further processing. A transfer device is configured to receive a group of input data elements from the sensors. Each input data element of this group of input data elements includes a point that specifies at least one position. The transfer device also includes a point-processing neural network. This point-processing neural network is configured to map the points of the group of input data elements to a regular output data structure. A processing device is configured to detect an object and/or ascertain properties of an object using the regular output data structure. For the conversion of points of an unordered point cloud to a regular structure, a point-processing neural network is provided.

### FIELD

The present invention relates to an apparatus and a method for processing sensor data as well as a sensor apparatus comprising such an apparatus.

### BACKGROUND INFORMATION

The operation of driver assistance systems, such as those used in fully or at least partially autonomous vehicles, requires the most accurate possible knowledge of the surroundings of the vehicle. A variety of sensor systems can be used to acquire said surroundings. For instance, radar sensors can be used to detect objects, their position and possibly their relative movement. The sensors provide data for individual points, and possibly also additional properties such as the backscatter coefficient or the like for these points. These point data can then be further processed in order to identify and possibly classify related objects.

Germany Patent Application No. DE 10 2018 214 959 A1, for example, describes a method for evaluating sensor data, wherein the sensor data are provided by at least one sensor. The sensor data can be used to detect objects and determine surface properties of the objects.

### SUMMARY

The present invention provides an apparatus and a method for processing sensor data, as well as a sensor system. Advantageous embodiments of the present invention are disclosed herein.

Provided according to an example embodiment of the present invention is:
An apparatus for processing sensor data with a transfer device. The transfer device is configured to receive a group of input data elements. Each input data element of this group of input data elements comprises a point that specifies at least one position. If necessary, at least one or more further properties can additionally also be specified for the points. The transfer device also comprises a point-processing neural network. This point-processing neural network is configured to map the points of the group of input data elements to a regular output data structure. The regular output structure can in particular have the structure of a grid of any dimension.

Provided according to an example embodiment of the present invention is furthermore:
A sensor system comprising a sensor device and an apparatus according to the present invention for processing the sensor data. The sensor device is configured to acquire a surroundings of the sensor by means of sensors. The sensor device is further configured to provide sensor data. The sensor data are provided as points that specify at least one position.

Provided according to an example embodiment of the present invention is also:
A method for processing sensor data comprising a step of receiving a group of input data elements. Each input data element comprises a point having a position. The points can optionally also include at least one further property. The method further comprises a step of mapping the points of the group of input data elements to a regular output data structure. The mapping is carried out using a point-processing neural network. The method comprises a step of outputting the regular output data structure. This regular output structure can be output to any other apparatus for further processing, for example.

In many areas of application, it is desirable to derive information about objects from sensor data. Different approaches can be used to achieve this. For instance, one possibility is to feed information from the sensor data to a neural network trained to ascertain objects and/or object properties from the sensor data. The sensor data can be made available in a variety of ways.

For instance, if the sensor data originates from a radar sensor, the sensor data can specify a position in the field of view of the sensor as well as at least one further property, such as a backscatter coefficient or the like. For an extended object in the field of view of the sensor, the sensor data can thus include point clouds comprising numerous points. For further processing, for example using a neural network or the like, these unordered point clouds have to be converted to a regular structure such as a raster or grid. Due to the discrete distances between the individual grid points, the sensor data from the original point cloud have to be transferred onto the discrete positions of the specified grid. Because of the discretization, this can potentially lead to inaccuracies or a reduction of the information content.

It is therefore an idea of the present invention to take this insight into account and to create a concept for the conversion of sensor data from an unordered point cloud to a regular data structure, which is suitable for allowing further processing to be carried out efficiently and with as little data loss as possible. According to an example embodiment of the present invention, for the conversion of points of an unordered point cloud to a regular structure, a point-processing neural network is provided. Such point-processing neural networks are capable of converting information from any number of points, or vectors to a regular structure, for example individual grid cells. The use of a point-processing neural network allows the aggregation of information from the points to the individual grid cells to be carried out particularly efficiently and with a very low flow of information.

The resulting regular data structure in the form of a grid is very advantageous or essential for further processing, for example by means of a convolutional neural network (CNN). The corresponding transformation of the point data from an initially unstructured point cloud into the regular structure thus makes it possible to provide the needed data structure efficiently and with as little data loss as possible.

According to one example embodiment of the present invention, the points further comprise data with at least one further property of the respective point. In principle, the further properties of the points can be any specific or even non-specific properties. In addition to specific properties such as a radar backscatter coefficient, any non-specific properties that are not specifically “explainable” are in particular possible as well. In such cases, a downstream neural network can also be trained on such non-specific properties. It is moreover also possible to provide different properties for different points.

According to one example embodiment of the present invention, the point-processing neural network includes a kernel point convolution (KPConv) or a graph neural network (GNN).

In principle, however, any other suitable point-processing neural networks that are capable of converting properties of the data of an unstructured product cloud into a regular structure efficiently and with low loss are possible as well.

According to one example embodiment of the present invention, the apparatus for processing the sensor data comprises a processing device. This processing device is configured to detect an object and/or ascertain properties of an object using the information in the output data. According to one embodiment, the properties of the objects can be a position, a dimension and/or orientation of the objects. Any other properties for characterizing the objects are of course possible too. Surface properties, direction of movement or the like can also be ascertained for a detected object, for instance.

According to one example embodiment of the present invention, the processing device comprises a neural network. This neural network can be configured to detect an object and/or ascertain properties of an object using the information specified in the output data structure. Any suitable neural networks appropriate to the application can be used. Such a neural network can be trained to the respective application beforehand using appropriate training data.

According to one example embodiment of the present invention, the processing device comprises a filter device. The filter device can be configured to filter and/or process the received input data elements according to another predefined rule. The filtering or processing can in particular be carried out before the points are mapped to the regular output data structure.

The sensor device processed by the device according to the present invention can be provided by a radar sensor, a LiDAR Sensor, an ultrasonic sensor and/or a camera, for instance. The camera can in particular be a 3D camera, for example a stereo camera or a time-of-flight camera.

The above configurations and further developments can be combined with one another in any desired manner if useful.

Further configurations, developments and implementations of the present invention also include not explicitly mentioned combinations of features of the present invention described above or in the following with respect to the design examples. Those skilled in the art will in particular also add individual aspects as improvements or additions to the respective basic forms of the present invention, in view of the disclosure herein.

### BRIEF DESCRIPTION OF THE DRAWINGS

Further features and advantages of the present invention are explained in the following with reference to the figures.

FIG. 1 shows a schematic illustration of a block diagram of a sensor system comprising an apparatus for processing the sensor data according to one example embodiment of the present invention.

FIG. 2 shows a schematic view of a schematic diagram illustrating the processing sensor data according to one example embodiment of the present invention.

FIG. 3 shows a flow chart as it forms the basis of a method for processing sensor data according to one example embodiment of the present invention.

### DETAILED DESCRIPTION OF EXAMPLE EMBODIMENTS

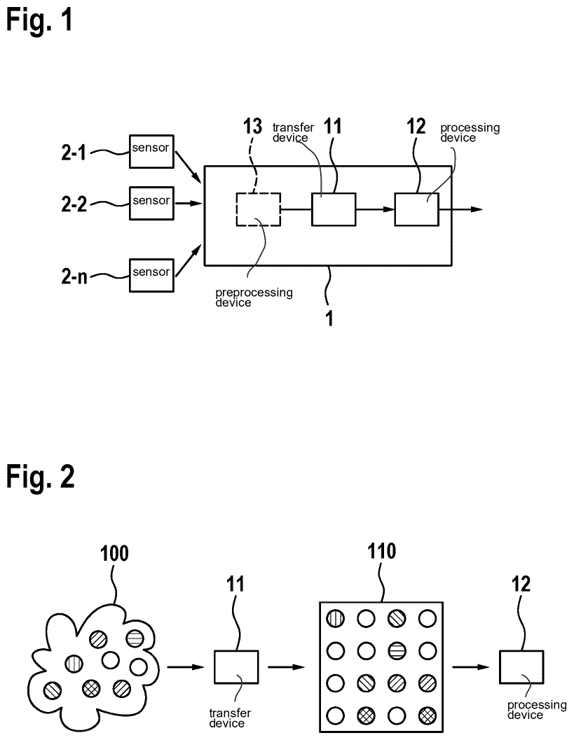

FIG. 1 shows a schematic illustration of a block diagram of a sensor system according to one example embodiment of the present invention. The sensor system can contain a plurality of sensors 2-i that acquire a surroundings by means of sensors and provide corresponding sensor data. The sensors 2-i can, for instance, be radar sensors, LiDAR sensors, ultrasonic sensors, cameras or any other suitable sensors capable of detecting objects in their surroundings, in particular within a predefined field of view. For example, a radar sensor can emit radar signals that are scattered and partially reflected by objects. The radar sensor can then receive and evaluate the radar echoes reflected back in the direction of the radar sensor in order to generate information about objects in the vicinity of the radar sensor. Such a radar sensor can provide information about individual points at which the radar signals have been at least partially reflected back to the radar sensor, for example. The information about such points can include a spatial position in the form of an azimuth and/or elevation angle or also in Cartesian coordinates, for instance. Further information, such as a relative speed, a backscatter coefficient, or the like, can be specified for such points as well. For extended objects, a plurality of such points can be output. These points can, for example, be referred to as a point cloud. Other sensors can similarly provide corresponding information about points on objects in the surroundings. In particular 3D cameras as stereo cameras or time-of-flight cameras, for example, can also provide spatial information about objects in the surroundings.

The data of the individual points always comprise at least one position. The data of a point can optionally also include one or more further properties. These can be any specific or also non-specific properties. In addition to specific properties such as a radar backscatter coefficient or the like, any non-specific properties that are not specifically “explainable” are in particular possible as well. In such cases, a downstream neural network can also be trained on such non-specific properties. It is moreover also possible to provide different properties for different points.

The sensor data provided by the sensors 2-i can then be transmitted, for example in the form of the above-described points or point clouds, to an apparatus 1 for processing the sensor data. This apparatus 1 can receive and process the sensor data and, for example, use this sensor data to identify objects and/or ascertain object features of objects in the field of view of the sensors 2-i. This evaluation of the sensor data can in particular be carried out using a neural network or the like as will be explained in the following.

In principle, the sensor data from the sensors 2-i can be provided to the apparatus 1 in any suitable manner. The sensor data can be transmitted to the apparatus 1 as an unordered list of the individual points and their feature or features, for example.

The sensor data can be received by the apparatus 1 for processing the sensor data and temporarily stored as needed. A preprocessing device 13, which carries out a preprocessing, for example a filtering, of the received sensor data, can optionally be provided. This can be used to reduce noise in the sensor data, for example, or carry out any other procedures for preprocessing the sensor data.

A transfer device 11 is also provided in the apparatus 1 for processing the sensor data. This transfer device 11 can convert the sensor data that is still unordered in the form of points to a regular output data structure. In such a regular structure, the sensor data can be provided as elements of a two or multidimensional grid, for instance. This desired regular data structure can in particular be a data structure that is suitable for further processing by a downstream processing device 12. If the processing device 12 is configured to further process the data in a two-dimensional or three-dimensional grid, for example, the necessary data structure can be provided by the transfer devices 11.

A point-processing neural network for mapping or projecting the data from the points of the initially unordered data cloud with the sensor data into the regular data structure is provided in the transfer device 11. This point-processing neural network can be a kernel point convolution (KPConv) or a graph neural network (GNN), for example. Any other suitable point-processing neural network is possible too, of course. The point-processing neural network can initially be trained in a suitable manner according to the requirements, in particular the desired regular output data structure and, if applicable, according to the data structure of the input data.

The output data from the transfer device 11, i.e. the data in the grid-shaped data structure according to the requirements of the processing device 12, can subsequently be fed to the processing device 12. The processing device 12 then evaluates the data in the provided grid-shaped data structure. Such an evaluation can be used by the processing device 12 to detect one or more objects, for instance. Additionally or alternatively, the processing device 12 can also ascertain properties of the detected objects. For example, a spatial location, a spatial extent, material properties, in particular surface properties, or the like can be ascertained for a detected object. It can also be possible to ascertain a direction of movement and/or a speed of an object. Of course, the data in the grid-like data structure can also be used to ascertain any other suitable properties of objects.

To process the data, the processing device 12 can use a neural network, for instance. Such a neural network can be trained beforehand in any desired manner.

FIG. 2 shows a schematic drawing to illustrate the concept for converting the sensor data from the sensors 2-i into the regular data structure for further processing by the processing device 12.

As shown here, a point cloud 100 comprising a plurality of points can be provided by the sensors 2-i, for example. The individual points respectively represent sensor data. In addition to a spatial and/or temporal position of the individual points, the points can possibly each have at least one further property, for example, in the case of a radar sensor, a backscatter coefficient. In principle, however, any suitable properties are possible. The individual data can be provided in the point cloud 100; for instance in the form of an unstructured list or the like.

The transfer device 11 can convert the unstructured data cloud 100 to a regular data structure 110. As already noted, a point-processing neural network, such as a KPConv or GNN, can be used to map or transform the points from the unstructured data cloud 100 into the regular data structure 110. This point-processing neural network can be trained beforehand in a suitable manner according to the respective requirements.

The regular data structure 110 can subsequently be provided to the processing device 12, and the processing device 12 can then detect objects and/or ascertain properties of objects based on said regular or grid-shaped data structure. This information can then be further processed in any desired manner.

The results of the processing device 12 can be used in a driver assistance system or a system for fully or at least partially autonomous driving of a motor vehicle, for instance. Any other suitable applications are possible too, however. The information can also be used to monitor a traffic space by means of a stationary installation, for example.

The information about detected objects can moreover also be used for access control. The object detection can also include recognition of persons, for instance, in particular facial recognition. It is also possible to monitor any area inside or outside a building by means of sensors, for instance, and trigger predefined events based on the object detection or classification. For example, an alarm can be triggered when unauthorized access, such as a break-in or the like, is detected.

In alternative embodiments, the above-described object detection or classification can also be used in industrial systems, for example in production facilities or the like. Of course, any other applications based on the object detection or classification according to the present invention using the grid data of plurality of grids with different scaling are possible as well.

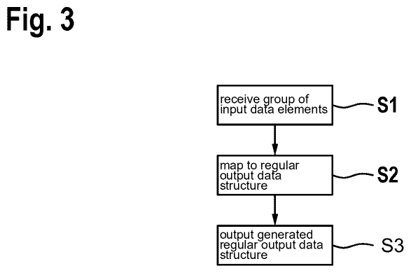

FIG. 3 shows a flow chart as it can form the basis of a method for processing sensor data according to one embodiment. The method can in principle comprise any steps as described above in connection with the sensor system or the apparatus 1 for processing the sensor data. Likewise, the above-described components can comprise any elements as described in the following in connection with the method for processing the sensor data.

In step S1, a group of input data elements is received. Each input data element comprises a point having a position. The points can furthermore optionally also include at least one further property.

In step S2, the points of the group of input data elements are then mapped to a regular output data structure. The mapping is carried out as already noted using a point-processing neural network.

Lastly, in step S3, the generated regular output data structure can be output.

In a further step, the data of the regular output data structure can then be processed to detect objects and/or ascertain properties of objects. The processing of the output data can in particular be carried out using a neural network.

In summary, the present invention relates to the processing sensor data from one or more sensors, wherein the sensor data are provided as an unordered point cloud. The points of this unordered sequence are then converted into a regular structure using a point-processing neural network and made available for further processing.

1-10. (canceled)

11. An apparatus for processing sensor data, comprising:
a transfer device configured to receive a group of input data elements, wherein each input data element of the group of input data elements includes a point having a position;
wherein the transfer device includes a point-processing neural network which is configured to map the points of the group of input data elements to a regular output data structure.

12. The apparatus according to claim 11, wherein each respective point of the points further include data with at least one further property of the respective point.

13. The apparatus according to claim 11, wherein the point-processing neural network includes a kernel point convolution or a graph neural network.

14. The apparatus according to claim 11, further comprising:
a processing device configured to detect an object and/or ascertain properties of an object using the regular output data structure.

15. The apparatus according to claim 14, wherein the properties of the object include a position of the object and/or a dimension of the object and/or orientation of object.

16. The apparatus according to claim 14, wherein the processing device includes a neural network which is configured to detect an object and/or ascertain properties of an object using the regular output data structure.

17. The apparatus according to claim 11, further comprising:
a filter device configured to filter and/or process the received sensor data elements according to a predefined rule before the points are mapped to the regular output data structure.

18. A sensor system, comprising:
a sensor device configured to acquire a surroundings using sensors and provide sensor data, wherein the sensor data are provided as points; and
an apparatus configured to process the sensor data, the apparatus including:
a transfer device configured to receive a group of input data elements,
wherein each input data element of the group of input data elements includes a point of the points and having a position;
wherein the transfer device includes a point-processing neural network which is configured to map the points of the group of input data elements to a regular output data structure

19. The sensor system according to claim 18, wherein the sensor device includes a radar sensor and/or a LiDAR sensor and/or an ultrasonic sensor and/or a camera.

20. A method for processing sensor data, comprising the following steps:
receiving a group of input data elements, wherein each input data element includes a point having a position;
mapping he points of the group of input data elements to a regular output data structure using a point-processing neural network; and
outputting the regular output data structure.
